(19) United States
(12) Patent Application Publication
(10) Pub. No.: US 2007/0044112 A1
(43) Pub. Date: Feb. 22, 2007

(54) Disk changer

(75) Inventor: Jui-Chiang Lin, Hsinchu City (TW)

Correspondence Address: BRUCE H. TROXELL, SUITE 1404, 5205 LEESBURG PIKE, FALLS CHURCH, VA, 22041, US

(73) Assignee: Lite-On It Corporation

(21) Appl. No.: 11/415,251

(22) Filed: May 2, 2006

(30) Foreign Application Priority Data
Aug. 17, 2005 (TW) 94128094

(51) Int. Cl. G11B 17/04

(52) U.S. Cl. 720/615

(57) ABSTRACT

A disk changer includes an outer casing receiving a disk receptacle and a reading device in juxtaposition. The receptacle has a plurality of disk-holding trays for supporting a plurality of disks respectively thereon. Each disk-holding tray is movable outward from the receptacle once the disk-holding disk is selected. Upper and lower extendable-and-retractable members are fastened between the casing and the reading device. Each extendable-and-retractable member includes a plurality of telescopically connected tubes abutting against upper and lower section of the reading device, and simultaneously prevents the unselected disk-holding trays from moving outward from the receptacle.

### FIELD OF THE INVENTION

The present invention relates to a disk changing mechanism, more particularly to a disk changer with a structure for preventing trays form ejecting out of a disk receptacle.

### BACKGROUND OF THE INVENTION

Optical disks become more and more important in the information field for backing up data and exchanging information due to its many advantages including a high storage capacity, easy to handle and carry, and a long preserving time for the stored data. A disk drive is used for recording the data on the optical disk and reproducing the data from the optical disk. A conventional disk drive generally is adapted to receive a single disk therein. Thus, one must manually replace the disk with desired ones, thereby inconveniencing the user. For this reason, a disk changer, which can contain a plurality of disks and replace the disk automatically, is produced.

FIG. 1 shows a conventional disk changer 2 including a disk receptacle 4, a reading device 6 disposed adjacent to the disk receptacle 4 and having a reading head (not visible in the drawing) for reading data in an optical disk 8, a disk pulling device 602 for pulling a selected disk outwardly from the disk receptacle 4, and a raising-and-lowering device 604 for lifting and lowering the reading device 6 so as to dispose the same at an elevation to receive the selected disk 8 therein.

The disk receptacle 4 includes a plurality of parallel disk-holding trays 402 for supporting a plurality of disks 8 respectively thereon. The raising-and-lowering device 604 can raise or lower the reading device 6 so as to dispose the same to be adjacent to and in alignment with a selected one of the disk-holding tray 402a. At this time, the pulling device 602 pulls the selected disk-holding tray 402a outward from the disk receptacle 4 into the reading device 6, wherein the disk 8 on the selected disk-holding tray 402a is disposed above the reading head in the reading device 6 to permit reading operation.

Some drawbacks encountered during use of the aforesaid conventional disk changer 2 are as follows:

Since the disk receptacle 4 and the reading device 6 are contained within the outer casing, an undesired disk-holding tray 402 may be rejected from the disk receptacle 4 under an unexpected shock. The rejected disk-holding tray 402 may collide against the reading device 6 during the lowering or raising operation thereof.

According to U.S. patent application Ser. No. 10/634,822, a disk changer includes a plurality of leaf springs mounted on an inner side wall of the disk receptacle for restraining the disk-holding trays in the disk receptacle. However, the leaf spring may suffer from spring fatigue after a period of use, thereby lowering the ability of the leaf spring to restrain the disk-holding trays in the disk receptacle.

### SUMMARY OF THE INVENTION

The object of the present invention is to provide a disk changer having the structure to prevent the unselected trays from moving out from the disk receptacle, thereby preventing collision between the unselected trays and the reading device as encountered during use of the conventional disk drive.

According to the object to the present invention, a disk changer is provided. The disk changer includes an outer casing; a disk receptacle disposed within the outer casing and having a plurality of disk-holding trays for supporting a plurality of disks respectively thereon, each of the disk-holding trays being movable out from the disk receptacle; a reading device disposed within the outer casing adjacent to the disk receptacle and movable upward and downward with respect to the disk receptacle in order to align with a selected one of the disk-holding trays for reading a respective disk supported on the elected one of the disk-holding trays; an upper extendable-and-retractable member disposed between the reading device and an upper portion of the outer casing, and including a plurality of telescopically connected tubes having a coupling portion fixed to the upper portion and a holding portion abutting against an upper section of the reading device; and a lower extendable-and-retractable member disposed between the reading device and a lower portion of the outer casing in alignment with the upper extendable-and-retractable member, and including a plurality of telescopically connected tubes having a coupling portion fixed to the lower portion and a holding portion abutting against a lower section of the reading device, thereby each of the plurality of disks is prevented moving out from the disk receptacle except the selected one on the selected disk-holding tray.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional disk changer wherein a outer casing is removed;

FIG. 2 is a lateral sectional view of a first embodiment of a disk changer according to the present invention;

FIG. 3A is a top view of a reading device employed in the first embodiment of a disk changer according to the present invention;

FIG. 3B is a front sectional view of the first embodiment of the disk changer according to the present invention;

FIG. 4 is a front sectional view of a second embodiment of the disk changer according to the present invention;

FIG. 5 is a top view of a first embodiment of a disk-holding tray employed in the disk changer of the present invention;

FIG. 6 is a top view of a second embodiment of the disk-holding tray employed in the disk changer of the present invention;

FIG. 7 is a sectional view of a first embodiment of an extendable-and-retractable member employed in the disk changer of the present invention; and

FIG. 8 is a sectional view of a second embodiment of the extendable-and-retractable member employed in the disk changer of the present invention.

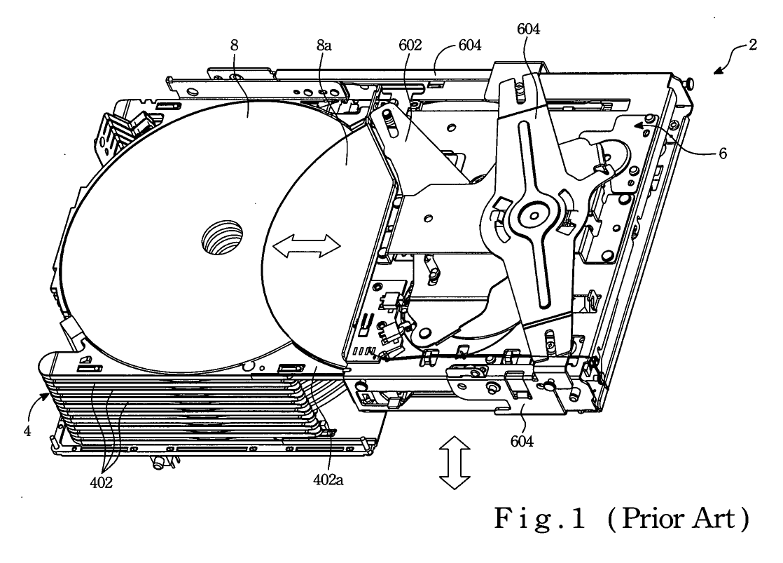

### DETAILED DESCCRIPTIONS OF THE PREFERRED EMBODIMENT

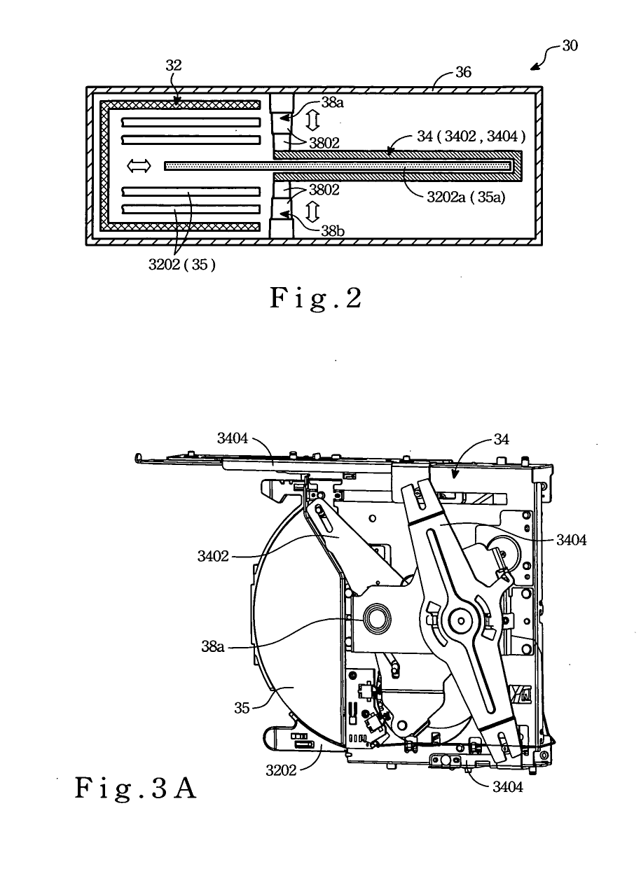

FIG. 2 is a lateral sectional view of the disk changer 30. The disk changer 30 includes an outer casing 36, a disk receptacle 32, a reading device 34, at least an upper extendable-and-retractable member 38a and at least a lower extendable-and-retractable member 38b.

The disk receptacle 32 is disposed in the outer casing 36, and has a plurality of disk-holding trays 3202 for supporting a plurality of disks 35 respectively thereon. Each of the disk-holding trays 3202 is movable out from the disk receptacle 32.

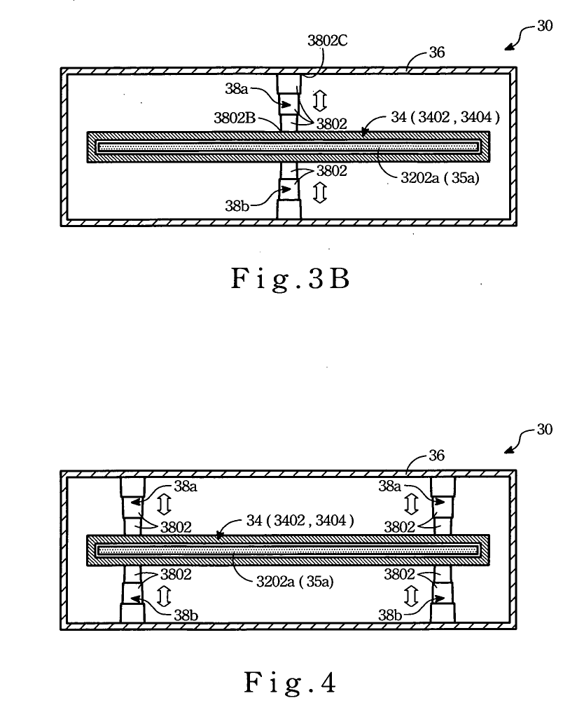

FIG. 3A is a top view illustrating the reading device 34 employed in a first embodiment of the disk changer of the present invention. The reading device 34 is disposed in the outer casing 36 adjacent to the disk receptacle 32, and includes a pulling device 3402 and a raising-and-lowering device 3404. The reading device 34 is movable upward and downward with respect to the disk receptacle 32 in order to align with a selected one of the disk-holding trays 3202a for reading a respective disk 35a supported on the selected disk-holding tray 3202a. As the reading device 34 is moved by the raising-and-lowering device 3404 to align with the selected disk-holding tray 3202a, the pulling device 3402, then, draws the selected disk-holding tray 3202a out from the disk receptacle into the reading device 34 so as to dispose the respective disk 35a above the reading head (not visible) for reading the data stored in the respective disk 35a. As to how to reading the disk 35 is known in the art, a detailed description is omitted herein for the sake of brevity.

The upper extendable-and-retractable member 38a is disposed between the reading device 34 and an upper portion of the outer casing 36 and adjacent to the disk receptacle 32. The upper extendable-and-retractable member 38a includes a plurality of telescopically connected tubes 3802 having a coupling portion fixed to the upper portion of the casing 36 and a holding portion abutting against an upper section of the reading device 34.

The lower extendable-and-retractable member 38b is disposed between the reading device 34 and an lower portion of the outer casing 36 in alignment with the upper extendable-and-retractable member 38a, and includes a plurality of telescopically connected tubes 3802 having a coupling portion fixed to the lower portion of the casing 36 and a holding portion abutting against a lower section of the reading device 34.

The upper and lower extendable-and-retractable member 38a, 38b are respectively disposed above and under the reading device 34 and are in alignment with each other. When the reading device 34 is moved up, the upper extendable-and-retractable member 38a is retracted, and the lower extendable-and-retractable member 38b is extended. On the contrary, when the reading device 34 is moved down, the upper extendable-and-retractable member 38a is extended, and the lower extendable-and-retractable member 38b is retracted. Under this condition, each of the disk-holding trays 3202 is prevented by the upper and lower extendable-and-retractable member 38a, 38b from moving out from the disk receptacle 32 except the selected disk-holding tray 3202a.

FIG. 3B is a front sectional view illustrating the first embodiment of the disk changer according to the present invention. The upper and lower extendable-and-retractable members 38a, 38b are respectively connected to the upper and lower sections of the reading device 34 and positioned at the center of a rear side, which is near the disk receptacle 32 of the reading device 34. The disk-holding trays 3202 are prevented by the upper and lower extendable-and-retractable members 38a, 38b from moving out of the disk receptacle 32 in the aforesaid manner.

FIG. 4 is a front sectional view illustrating a second embodiment of the disk changer 30 of the present invention. As illustrated, each of the upper and lower extendable-and-retractable members 38a, 38b includes a pair of telescopically connected tubes 3802 respectively disposed at two lateral positions of a rear side, which is near the disk receptacle 32 of the reading device 34. When the disk-holding trays 3202 are to be ejected from the disk receptacle 32 under an unexpected vibration, the telescopically connected tubes 3802 of the upper and lower extendable-and-retractable members 38a, 38b can stop the movement of the disk-holding trays 3202.

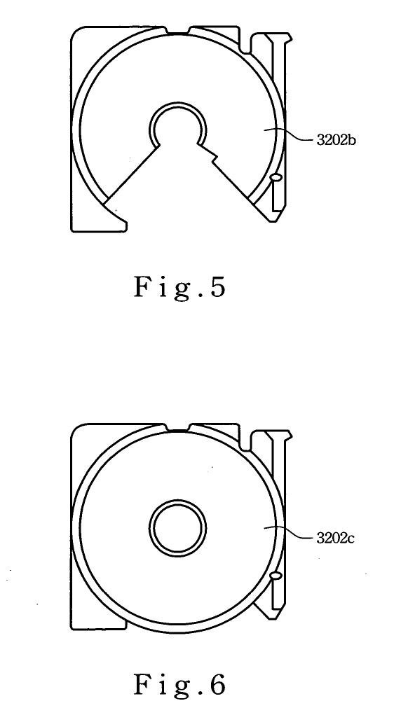

FIG. 5 is a top view of one embodiment of the disk-holding tray 3202b employed in the disk changer 30 of the present invention. As illustrated, each of the disk-holding trays 3202b has a peripheral notch facing the reading device 34. The telescopically connected tubes 3802 (see FIG. 2) of the upper and lower extendable-and-retractable members 38a, 38b contact the peripheries of the disks on the disk-holding trays 3202b to prevent moving out from the disk receptacle 32 except the selected one of said disk-holding trays 3202a.

FIG. 6 is a top view of another embodiment of the disk-holding tray 3202c employed in the disk changer 30 of the present invention. As illustrated, each of the disk-holding trays 3802c has a generally square configuration. The telescopically connected tubes 3802 (see FIG. 2) of the upper and lower extendable-and-retractable members 38a, 38b contact the peripheries of the disk-holding trays 3202c adjacent to the reading device 34 to prevent the disk-holding trays 3802c form moving out from the disk receptacle 32 except the selected disk-holding tray.

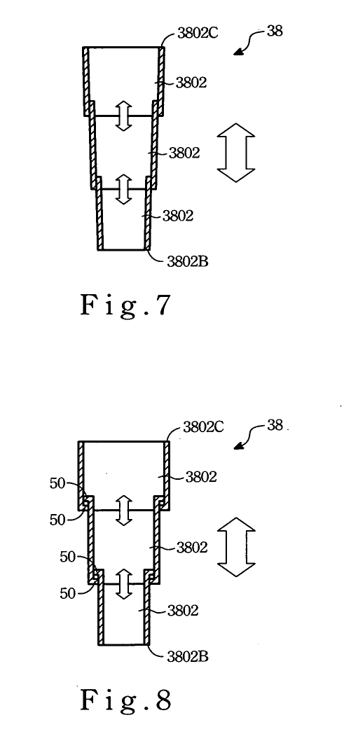

FIG. 7 is a sectional view of a first embodiment of an extendable-and-retractable member employed in the disk changer of the present invention. Referring to FIG. 7, each of the telescopically connected tubes 3802 of the upper extendable-and-retractable member 38a has a lower end and an upper end that extends divergently from the lower end to form a diameter of the lower end that is smaller than that of the upper end. The diameter of upper end of each tube is smaller than that of lower end of its upper one. Thus, each tube is slidably engaged within its upper one to form the upper extendable-and-retractable member 38a. The upper end of the highest tube among the telescopically connected tubes 3802 of the upper extendable-and-retractable member 38a is defined as the coupling portion 3802C for fixing to the upper portion of the casing 36. The lower end of the lowest tub among the telescopically connected tubes 3802 of the upper extendable-and-retractable member 38a is defined as the holding portion 3802B for abutting against the upper section of the reading device 34.

In the same manner, each of the telescopically connected tubes 3802 of the lower extendable-and-retractable member 38b has a lower end and an upper end that extends convergently from the lower end to form a diameter of the lower end that is larger than that of the upper end. The diameter of lower end of each tube is smaller than that of upper end of its lower one. Thus, each tube is slidably engaged within its lower one to form the lower extendable-and-retractable member 38b. The lower end of the lowest tube among the telescopically connected tubes 3802 of the lower extendable-and-retractable member 38b is defined as the coupling portion 3802C for fixing to the lower portion of the casing 36. The upper end of the highest tube among the telescopically connected tubes 3802 of the lower extendable-and-retractable member 38b is defined as the holding portion 3802B for abutting against the lower section of the reading device 34.

FIG. 8 is a sectional view of a second embodiment of the extendable-and-retractable member employed in the disk changer of the present invention. The structure of the second embodiment of the extendable-and-retractable member 38 is similar to that of the first embodiment of the extendable-and-retractable member. The different is that each of the telescopically connected tubes 3802 of the upper extendable-and-retractable member 38a further has an inward flange 50, which is formed at the lower end thereof, and an outward flange 50, which is formed at the upper end thereof. As each tube is slidably engaged within its upper one, the outward flange 50 of the tube is engaged with the inward flange 50 of its upper one so as to prevent disengagement between them.

In the same manner, each of the telescopically connected tubes 3802 of the lower extendable-and-retractable member 38a further has an inward flange 50, which is formed at the upper end thereof, and an outward flange 50, which is formed at the lower end thereof. As each tube is slidably engaged within its lower one, the outward flange 50 of the tube is engaged with the inward flange 50 of its lower one so as to prevent disengagement between them.

By virtue of arrangement of the upper and lower extendable-and-retractable members 38a, 38b in the disk changer 30 of the present invention, the unselected disk-holding trays are prevented from moving out of the disk receptacle 32. Since only the selected disk-holding tray is allowed into the reading device 34, collision between the reading device 34 and the unselected disk-holding tray during movement of the reading device 34 in the upward-and-downward direction can be avoided.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A disk changer comprising:
an outer casing;
a disk receptacle disposed within said outer casing, and having a plurality of disk-holding trays for supporting a plurality of disks respectively thereon, each of said disk-holding trays being movable outward from said disk receptacle;
a reading device disposed within said outer casing adjacent to said disk receptacle and movable upward and downward with respect to said disk receptacle in order to align with a selected one of said disk-holding trays for reading a respective disk supported on said selected one of said disk-holding trays;
an upper extendable-and-retractable member disposed between said reading device and an upper portion of said outer casing, and including a plurality of telescopically connected tubes having a coupling portion fixed to said upper portion and a holding portion abutting against an upper section of said reading device; and
a lower extendable-and-retractable member disposed between said reading device and a lower portion of said outer casing in alignment with said upper extendable-and-retractable member, and including a plurality of telescopically connected tubes having a coupling portion fixed to said lower portion and a holding portion abutting against a lower section of said reading device;
whereby, each of said plurality of disk-holding trays is prevented from moving out from said disk receptacle except said selected one of said disk-holding trays.

2. The disk changer according to claim 1, further comprising a pulling device for pulling said selected one of said disk-holding trays out from said disk receptacle for reading said respective disk supported on said selected one of said disk-holding trays.

3. The disk changer according to claim 1, further comprising a raising-and-lowering device for moving said reading device up and down with respect to said disk receptacle.

4. The disk changer according to claim 1, wherein each of said disk-holding trays has a peripheral notch facing said reading device, said telescopically connected tubes of said upper and lower extendable-and-retractable members contacting the peripheries of said disks on said disk-holding trays to prevent moving out from said disk receptacle except said selected one of said disk-holding trays.

5. The disk changer according to claim 1, wherein each of said disk-holding trays has a generally square configuration, said telescopically connected tubes of said upper and lower extendable-and-retractable members contacting the peripheries of said disk-holding trays to prevent moving out from said disk receptacle except said selected one of said disk-holding trays.

6. The disk changer according to claim 1, wherein each of said telescopically connected tubes of said upper extendable-and-retractable member has a lower end and an upper end that extends divergently from said lower end, wherein a diameter of upper end of each tube is smaller than that of lower end of its upper one, thereby, each tube is slidably engaged within its upper one to form said upper extendable-and-retractable member.

7. The disk changer according to claim 1, wherein each of said telescopically connected tubes of said lower extendable-and-retractable member has a lower end and an upper end that extends convergently from said lower end, wherein a diameter of lower end of each tube is smaller than that of upper end of its lower one, thereby, each tube is slidably engaged within its lower one to form said lower extendable-and-retractable member.

8. The disk changer according to claim 6, wherein each of said telescopically connected tubes of said upper extendable-and-retractable member further has an inward flange, which is formed at said lower end thereof, and an outward flange, which is formed at said upper end thereof, wherein said outward flange of said each of said telescopically connected tubes is engaged with said inward flange of its upper one.

9. The disk changer according to claim 7, wherein each of said telescopically connected tubes of said lower extendable-and-retractable member further has an inward flange, which is formed at said upper end thereof, and an outward flange, which is formed at said lower end thereof, wherein said outward flange of said each of said telescopically connected tubes is engaged with said inward flange of its lower one.

10. The disk changer according to claim 1, wherein said upper extendable-and-retractable member includes a pair of said telescopically connected tubes disposed between said reading device and said outer casing.

11. The disk changer according to claim 10, wherein said lower extendable-and-retractable member includes a pair of said telescopically connected tubes disposed between said reading device and said outer casing respectively aligned with said pair of telescopically connected tubes of said upper extendable-and-retractable member.
